(19) United States
(12) Patent Application Publication
(10) Pub. No.: US 2015/0178760 A1
(43) Pub. Date: Jun. 25, 2015

(54) METHODS FOR VALUATION OF RECYCLING CREDITS

(71) Applicant: Qingyue Chen, Beijing (CN)

(72) Inventor: Qingyue Chen, Beijing (CN)

(73) Assignee: EMPIRE TECHNOLOGY DEVELOPMENT LLC, Wilmington, DE (US)

(21) Appl. No.: 14/417,147

(22) PCT Filed: Jun. 24, 2012
(86) PCT No.: PCT/CN2012/079074

§ 371 Date: Jan. 24, 2015

(51) Int. Cl. G06Q 30/02; G06Q 10/00

(52) U.S. Cl. CPC G06Q 30/0226; G06Q 10/30

(57) ABSTRACT

Methods and systems for determining a value of recycling credits take into consideration the manufacturer of products that were turned in for recycling and correlates each credit with the manufacturer. The value of the credits may then be enhanced by a manufacturer to provide an incentive to purchase products made by that manufacturer.

### BACKGROUND

Recycling provides a system for processing used materials or waste into new products in order to prevent the waste of potentially useful materials, to reduce energy usage from the production of new materials, to reduce air pollution caused by the incineration of waste materials, and to reduce water pollution as a result of landfilling. Recycling can reduce the need for conventional waste disposal and lower greenhouse gas emissions as compared with virgin production of new materials.

Recycling efforts have gradually gained traction at city, state and federal levels. For example, many jurisdictions provide recycling bins to encourage residents to increase recycling and to reduce waste production. However, if additional incentives were provided to consumers, it would further encourage consumers to recycle their used recyclable materials.

To encourage recycling of electronic devices, consumers who submit their electronic devices for recycling may be compensated with cash or credits. However, existing recycling methods do not differentiate the source or brand of the recycled electronic products when giving back cash or credits. Also, manufacturers have minimal incentive to participate in electronic waste recycling because it often incurs extra cost with no direct benefit to the manufacturer. There remains a need for encouraging participation in recycling both by the consumer and by the manufacturers.

### SUMMARY

Presently disclosed is a system and method for encouraging recycling of used products by enhancing credit values of recycled products and applying the value towards the purchase of additional products.

In an embodiment, a method for establishing a value of recycling credits usable for a product being considered for purchase includes identifying a product being considered for purchase by a consumer, determining a manufacturer of the product, and receiving recycling credits associated with the consumer by a processing device. Each recycling credit has an initial credit value and is associated with a corresponding manufacturer of a recycled material. The method also includes comparing the manufacturer of the product with the manufacturer associated with each recycling credit by the processing device, and for each recycling credit associated with the manufacturer of the product, multiplying, by the processing device, the initial credit value of the recycling credit by a factor to obtain an additional credit value for the recycling credit. The method also includes summing the additional credit values and the initial credit values by the processing device to determine a total recycling credit value usable as credit for purchase of the product.

In an embodiment, a method for establishing a value of recycling credits and comparing the value of the recycling credits for products being considered for purchase includes identifying a plurality of products being considered for purchase by a consumer, determining a manufacturer of each product, and receiving credits associated with the consumer by a processing device. Each recycling credit has an initial credit value and is associated with a corresponding manufacturer of a recycled material. The method also includes, for each product, comparing the manufacturer of the product with the manufacturer associated with each recycling credit by the processing device, and for each recycling credit associated with the manufacturer of the product, multiplying, by the processing device, the initial credit value of the recycling credit by a factor to obtain an additional credit value for the recycling credit. The method also includes summing the additional credit values and the initial credit values by the processing device to determine a total recycling credit value usable as credit for purchase of the corresponding product, and determining, by the processing device, the product having the largest recycling credit value.

In an embodiment, a method for establishing a value of recycling credits usable for a product being considered for purchase includes identifying a product being considered for purchase by a consumer, determining a manufacturer of the product, and receiving recycling credits associated with the consumer by a processing device. Each recycling credit has an initial credit value and is associated with a manufacturer of a recycled material. The method also includes assigning, by the processing device, each manufacturer a corresponding factor for enhancing the initial credit value of recycling credits associated with the manufacturer, where the value of each factor in relation to the product being considered for purchase is established by the manufacturer of the product, and for each recycling credit, multiplying, by the processing device, the initial credit value of the recycling credit by the corresponding factor to obtain additional credit values for the recycling credits. The method also includes summing the additional credit values and the initial credit values by the processing device to determine a total recycling credit value usable as credit for purchase of the product being considered.

In an embodiment, a system for valuation of recycling credit on the basis of at least one product being considered for purchase by a consumer includes a processing device and a non-transitory computer-readable storage medium in operable communication with the processing device, where the computer-readable storage medium contains one or more programming instructions that, when executed, cause the processing device to: identify a product being considered for purchase by the consumer, determine a manufacturer of the product, and receive recycling credits associated with the consumer, wherein each recycling credit has an initial credit value and is associated with a corresponding manufacturer of a recycled material. In addition, the computer-readable storage medium contains one or more programming instructions that, when executed, cause the processing device to compare the manufacturer of the product with the manufacturer associated with each recycling credit, and for each recycling credit associated with the manufacturer of the product, multiply the initial credit value of the recycling credit by a factor to obtain an additional credit value for the recycling credits, and sum the additional credit values and the initial credit values to determine a total recycling credit value usable as credit for purchase of the product being considered.

In an embodiment, a system for valuation of recycling credit and comparing the value of the recycling credits for purchase of a product by a consumer includes a processing device, and a non-transitory computer-readable storage medium in operable communication with the processing device. The computer-readable storage medium contains one or more programming instructions that, when executed, cause the processing device to: identify a plurality of products being considered for purchase by a consumer, determine a manufacturer of each product, and receive recycling credits associated with the consumer. Each recycling credit has an initial credit value and is associated with a corresponding manufacturer of a recycled material. In addition, for each product, the computer-readable storage medium contains one or more programming instructions that when executed, cause the processing device to compare the manufacturer of the product with the manufacturer associated with each recycling credit, and for each recycling credit associated with the manufacturer of the product, multiply the initial credit value of the recycling credit by a factor to obtain an additional credit value for the recycling credit, and sum the additional credit values and the initial credit values to determine a total recycling credit value usable as credit for purchase of the corresponding product. The computer-readable storage medium also contains one or more programming instructions that when executed, cause the processing device to determine the product having the largest recycling credit value.

### BRIEF DESCRIPTION OF THE FIGURES

FIG. 1 depicts an illustrative database system for valuation of recycling credits according to an embodiment.

FIG. 2 depicts a processing system for valuation of recycling credits according to an embodiment.

FIG. 3 depicts a flow diagram for an illustrative method for valuation of recycling credits according to an embodiment.

### DETAILED DESCRIPTION

In today's society, with the rapid advancement of technology, electronic products have almost reached the point of being a necessity for many people. Hand-held electronic devices, such as cell phones, e-readers, and tablet computers are becoming commonplace. In addition, typical homes now also have numerous televisions, laptop computers, desktop computers, monitors, printers, portable media players, handheld electronic games, and video game consoles.

Electronic products typically have a limited life-span. Sometimes the life span can be shortened due to damage caused by dropping, mishandling, or moisture infiltration. Some products simply become obsolete due to rapid technological advances. Some products, while still functioning as intended, may simply no longer be needed, but may still have value. Many electronic components, even though no longer wanted or needed, may have some value for resale if they are still functional, or if broken or damaged, may have some value in their parts. Recycling centers have been established for collecting electronic devices and offering the consumer a ‘value’ for devices turned in.

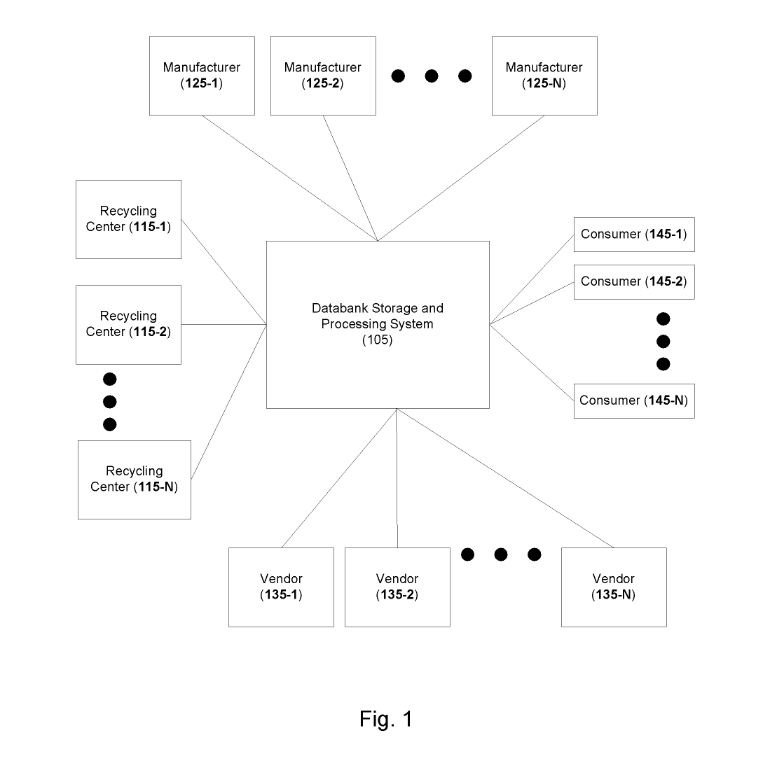

When consumers submit electronic devices for recycling, they may receive cash, or alternatively, recycling credits which may be usable towards the purchase of other items. The recycling credits may be in the form of a credit voucher, and/or the value of the credits may be stored in a central storage databank and processing system 105 in FIG. 1. The system 105 may store and provide access to information such as the value of devices that are being recycled, as well as information regarding the particular consumer (145-1, 145-2 . . . 145-N) and how much recycling credit the consumer has accumulated. A number of recycling centers (115-1, 115-2 . . . 115-N) may have access to the system 105 to provide a consumer 145-N with a value for recycled items and then assign to the consumer a number of recycling credits for the value. For example, the credits may have a value of 1 credit per dollar value of the recycled item. The consumer's information and number of credits assigned maybe stored in the system 105. Alternatively, the credits may have a lower value, such as for example, 0.5 credits per dollar value, or possibly a greater value such as 2 credits per dollar value.

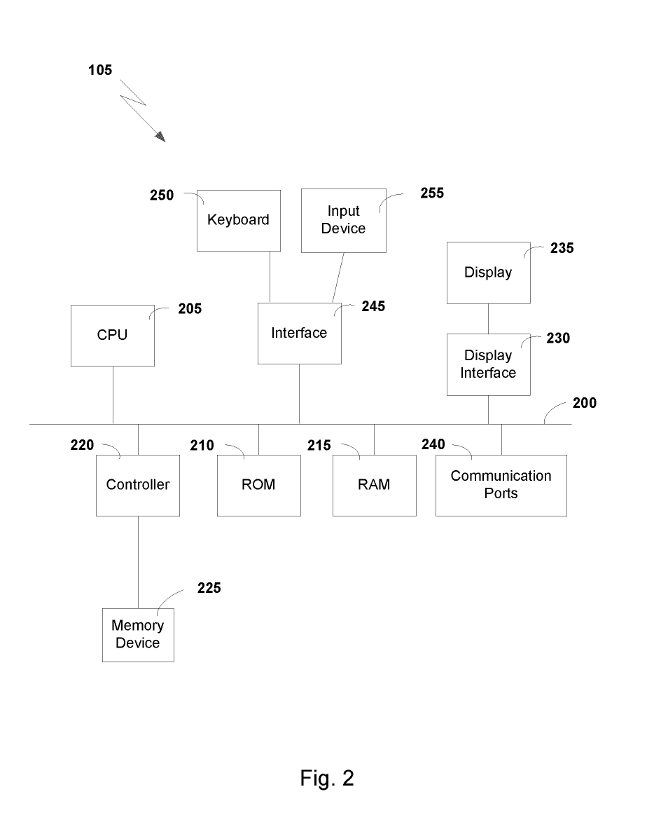

An exemplary processing system 105 including hardware that may be used to view and/or access data and contain or implement program instructions according to embodiments is disclosed in reference to FIG. 2. A bus 200 serves as the main information highway interconnecting the other illustrated components of the hardware. CPU 205 is the central processing unit of the system, performing calculations and logic operations required to execute a program. CPU 205, alone or in conjunction with one or more of the other elements disclosed in FIG. 2, is an exemplary processing device, computing device or processor as such terms are used within this disclosure. Read only memory (ROM) 210 and random access memory (RAM) 215 constitute exemplary memory devices (i.e., processor-readable non-transitory storage media, wherein non-transitory processor-readable media comprise all computer-readable media, with the sole exception being a transitory, propagating signal.)

A controller 220 interfaces with one or more optional memory devices 225 to the system bus 200. These memory devices 225 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 210 and/or the RAM 215. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 230 may permit information from the bus 200 to be displayed on the display 235 in audio, visual, graphic or alphanumeric format. Communication with external devices, such as a print device, may occur using various communication ports 240. An exemplary communication port 240 may be attached to a communications network, such as the Internet or an intranet.

The hardware may also include an interface 245 which allows for receipt of data from input devices such as a keyboard 250 or other input device 255 such as a mouse, a joystick, a touch screen, a remote control, a pointing device, a video input device and/or an audio input device.

With reference again to FIG. 1, consumers 145-N may have access to the system 105 via a username and appropriate password to check on their accumulated credits. In addition, when a consumer is ready to buy a product, for example, a new tablet computer, the consumer may go to any participating vendor (135-1, 135-2 . . . 135-N). The vendor may also have access to the system 105 via a username and password. The vendor may retrieve the consumer's credits, withdraw the credits and apply the credits towards a purchase by accessing the system 105.

As a way to encourage or provide an additional incentive to recycle products, an additional attribute may be assigned to each recycling credit that provides an additional promotional value to the recycling credits. For example, each credit may be assigned a value that corresponds to the brand or manufacturer of the product that was recycled. Any participating manufacturer (125-1, 125-2 . . . 125-N) may determine a value to apply to the recycling credits.

Each manufacturer, in order to encourage recycling of their products and brand loyalty in the purchase of additional products, may apply a valuation factor to recycling credits earned for their products that may increase the value of the credits from their products when the consumer purchases another of their products. In this manner, if the consumer chooses to buy products from the same manufacturer/brand as the product recycled, their credits may be worth more by a premium predetermined by the particular manufacturer.

In an embodiment, the manufacturer may apply an additional value to only credits associated with its own products that were recycled. In an alternative embodiment, a manufacturer may, for example, wish to promote its name and product line and decide to provide an additional value to credits associated with any products that were recycled. In this case, the same value may be applied to all credits, or different values may be applied to credits for different manufacturers.

When a consumer 145-N turns in electronic devices for recycling, the consumer may be compensated with recycling credits. The credits may contain information regarding the manufacturer (or brand) 125-N of the recycled device, and the information may be stored in a central database 105. When the consumer 145-N is ready to buy another electronic device, they may use the credits to totally or partially offset the expense, based on a predetermined exchange rate, which may be, for example, $1 per credit. However, if the credits are used to purchase items of the same brand/manufacturer 125-N, the credits may be worth more, for example, $1.50 per credit. The extra $0.50 premium may ultimately be funded by the brand/manufacturer of the product.

In a further embodiment, at the time of purchase, a consumer may wish to not use credits from one manufacturer's products (i.e. Sony) for purchase of products from a different manufacturer (i.e. Apple), thereby saving the associated credits and any extra value of the credits for purchase of devices from corresponding manufacturers.

In general, if a consumer chooses to buy products from the same manufacturer/brand as the product which was recycled, their credits would be worth more by a predetermined premium. In this manner, consumers are provided with an incentive to stay with the original brand due to better exchange rate of the recycling credits. Therefore, companies/manufacturers (especially the larger ones with large existing customer bases) also have an incentive to join the recycling program as a way to retain their market share. Also, the extra cost from these companies (e.g. to fund the credit and the credit premium) may be realized as marketing investment rather than lost costs. This may particularly be true for funding the credit premium, because whenever the company is funding these premiums, it means that consumers are patronizing their products repeatedly. Manufacturers who do not participate may lose market share as consumers have the potential to benefit from the manufacturers who do participate.

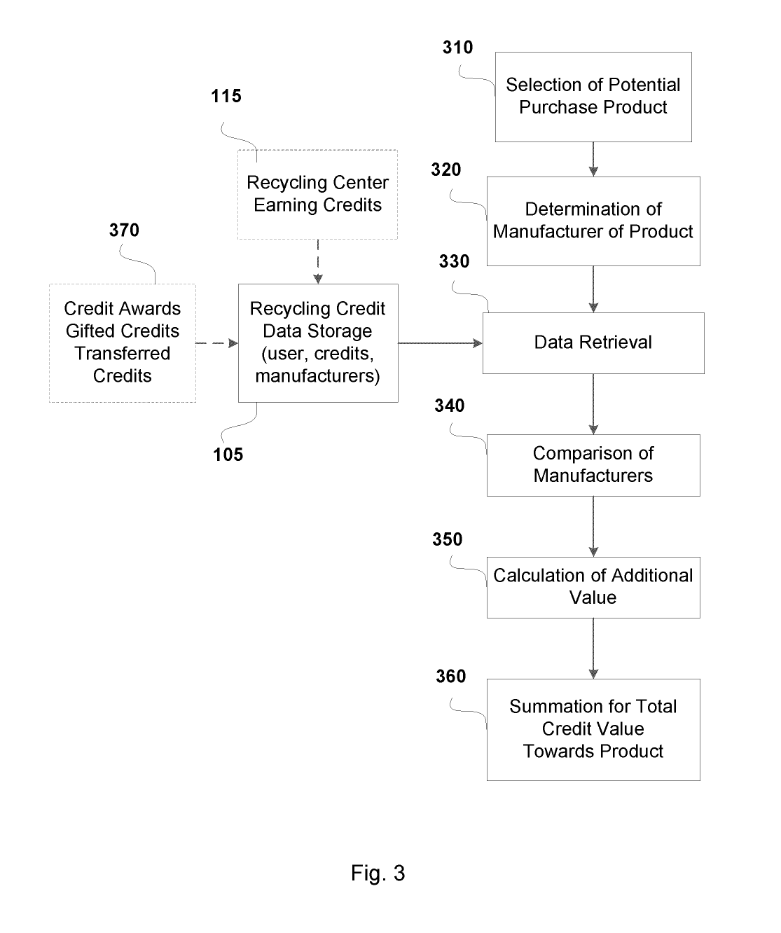

As also generally depicted in FIG. 3, a consumer may obtain credit values by other methods 370. For example, a parent may have accumulated credits that they may transfer to a child. Credits may also possibly be obtained through gifts or awards programs.

A processing system (such as system 105 in FIG. 2) for determining a value of recycling credits may be located at an establishment. The system may include a processor and a memory device that includes instructions for determining the value of recycling credit in relation to a new product which will be, or is being purchased. The system may be configured to receive a first set of information from recycling centers when a consumer returns goods to be recycled, wherein the first set of information will relate to the specific consumer, the number of credits being given to the consumer for each turned-in item, and also a correlation between the credits and the manufacturer of the product to which the credits apply. The system may also be configured to receive information regarding the product, or products, being considered for purchase. The system may be configured to compare the manufacturer of the new product being considered for purchase with the manufacturer corresponding to each recycling credit to determine and output a value of the recycling credits in relation to the product being purchased.

### Example 1

### Valuation of Recycling Credits

With reference to FIG. 3, a consumer may have an original functioning Apple iPad®, for example, that may have a value of about $100.00 if turned in at a recycling center 115. The recycling center will give the consumer 100 recycling credits and attach to those credits an Apple designation. The information may be stored in a central data/processing unit 105. The consumer may prefer iPads®, and decide to possibly purchase a new iPad® at step 310. The manufacturer of the iPad®, Apple Inc., will then be determined at a step 320 and recycling information will be retrieved in a step 330 from the system 105. A comparison of the manufacture of the product being considered with the manufacturer designations associated with the recycling credits may be made at step 340. For purposes of this example, Apple Inc. may have a policy of applying an enhancement factor of 0.5 to each recycling credit from an Apple product which is used for purchase of another Apple product. The consumer will have 100 Apple credits and the value calculation at step 350 will determine that an additional 50 credits will be applied (100×0.5=50) by Apple Inc. towards the purchase of another iPad®. A total summation of credit value at step 360 will then indicate that 150 credits (100 recycling credits+50 Apple credits) will be available for purchase of another Apple product.

On the other hand, if the consumer would decide that they wanted to possibly purchase a Samsung Galaxy® Tab instead, only the original 100 recycling credits would be indicated as being available for a purchase of the Galaxy®.

### Example 2

### Comparative Valuation of Credits with Loyalty Enhancement

Over a period of about 4 years, a consumer will turn in the following items for recycling and will receive the indicated credits: a Nintendo 3DS®—15 credits; an LG cell phone—5 credits; a Sony Playstation® 3—30 credits; a broken Apple iPad®—30 credits; a Sony computer monitor—20 credits; a Samsung smartphone—20 credits; an Amazon Kindle®—10 credits; a Sony laptop computer—50 credits; and an Apple iPhone®—20 credits.

The consumer will be considering buying a new laptop computer and would like to know which brand to buy to get the best value for the recycling credits. At the time Sony Corporation will be offering an enhancement of 0.5 for any credits obtained from recycled Sony products and used to purchase a new Sony product, and Apple Inc. will be offering an enhancement of 0.75 for any credits obtained from recycled Apple products and used towards the purchase of a new Apple product. The consumer will also consider the ASUS brand.

The consumer will provide the processing center with the three possible brands that are being considered and will receive back the following information in Table 1.

TABLE 1

| | | Additional | Additional | Additional |
|---|---|---|---|---|
| | | Value for | Value for | Value for |
| | Credits | Sony | Apple | ASUS |
| Item Recycled | Received | x0.5 | x0.75 | x0.0 |
| Sony Playstation ® 3 | 30 | +15.00 | | |
| Sony computer monitor | 20 | +10.00 | | |
| Sony laptop computer | 50 | +25.00 | | |
| Apple iPhone ® | 20 | | +15.00 | |
| Apple iPad ® | 30 | | +22.50 | |
| Samsung smartphone | 20 | | | |
| Amazon Kindle ® | 10 | | | |
| Nintendo 3DS ® | 15 | | | |
| LG cell phone | 5 | | | |
| Credits/Credit Value @ | 200 | $200.00 | $200.00 | $200.00 |
| $1/credit | | | | |
| Added Value | | +$50.00 | +$37.50 | +0.00 |
| Total Value | | $250.00 | $237.50 | $200.00 |

Based on the indicated enhancement rates, the value towards an ASUS product will be only the credit value of $200.00, the enhanced value for an Apple product will be $237.50, and the enhanced value for a Sony product will be $250.00. Thus, even though Apple Inc. will be offering a higher enhancement factor, the current consumer will receive the best value for this combination of recycling credits if the credits are used towards the purchase of a Sony product.

In a variant of this example, the consumer, may decide to purchase the Sony product, and at their discretion may also decide that they want to retain the 50 Apple credits in their account for a future Apple purchase. The consumer will then have to spend an additional $50.00 for the Sony computer, but at the same time will be retaining a potential $87.50 for a future Apple product.

### Example 3

### Valuation of Credits with Special Promotions

Using the same recycled credits as the above-scenario, a company such as ASUS may want to increase product sales and awareness of the company, and therefore advertises that for the next 30 days they will provide an enhancement of 0.25 for any credits from any manufacturers. The consumer will still be considering the same three products, and with the application of the same enhancement values of 0.5 for Sony products and 0.75 for Apple products, the consumer will be provided with the information in Table 2.

TABLE 2

| | | Additional | Additional | Additional |
|---|---|---|---|---|
| | | Value for | Value for | Value for |
| | Credits | Sony | Apple | ASUS |
| Item Recycled | Received | x0.5 | x0.75 | x0.25 |
| Sony Playstation ® 3 | 30 | +15.00 | | +7.50 |
| Sony computer monitor | 20 | +10.00 | | +5.00 |
| Sony laptop computer | 50 | +25.00 | | +12.50 |
| Apple iPhone ® | 20 | | +15.00 | +5.00 |
| Apple iPad ® | 30 | | +22.50 | +7.50 |
| Samsung smartphone | 20 | | | +5.00 |
| Amazon Kindle ® | 10 | | | +2.50 |
| Nintendo 3DS ® | 15 | | | +3.75 |
| LG cell phone | 5 | | | +1.25 |
| Credits/Credit Value @ | 200 | $200.00 | $200.00 | $200.00 |
| $1/credit | | | | |
| Added Value | | +$50.00 | +$37.50 | +50.00 |
| Total Value | | $250.00 | $237.50 | $250.00 |

With the additional enhancement offer by ASUS, the current consumer will receive the best value for this combination of recycling credits if they are used towards the purchase of a Sony product or an ASUS product.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone,Balone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method to establish a value of recycling credits usable for at least one product being considered for purchase, the method comprising:
identifying the at least one product being considered for purchase by a consumer;
determining a manufacturer of the at least one product;
communicating with a data storage and processing system to receive recycling credits associated with the consumer, wherein the data storage and processing system comprises a processing device and a database that stores each recycling credit along with an associated initial credit value and a corresponding manufacturer of a material recycled for the recycling credit;
comparing, by the processing device, the manufacturer of the at least one product with the corresponding manufacturer of the material recycled for each recycling credit;
for each recycling credit associated with the manufacturer of the at least one product, multiplying, by the processing device, the associated initial credit value of the recycling credit by a factor to obtain an additional credit value for the recycling credit;
summing, by the processing device, the additional credit values and the initial credit values to determine a total recycling credit value usable as credit for purchase of the at least one product; and
providing the total recycling credit value to the consumer.

2. The method of claim 1, further comprising establishing, by the manufacturer of the at least one product, a value of the factor, wherein the value of the factor is greater than zero.

3. (canceled)

4. The method of claim 1, further comprising:
providing the initial credit values of the recycling credits with funding from a recycling center; and
providing a value of the additional credit values with funding from the manufacturer of the at least one product.

5. The method of claim 1, wherein:
the method establishes a value of recycling credits usable for purchase of a new product; and
communicating with the data storage and processing system comprises receiving recycling credits associated with recycling of electronic products.

6. The method of claim 1, further comprising storing information regarding one or more of: the consumer, recycling credits of the consumer, manufacturers associated with the recycling credits, and a value of the factor in the database for access by one or more of: the consumer, the manufacturers, recycling centers and retail outlets.

7. (canceled)

8. The method of claim 1, wherein communicating with the data storage and processing system comprises receiving recycling credits associated with recycling of at least one of: cell phones, televisions, tablet computers, e-readers, laptop computers, monitors, desktop computers, portable media players, handheld electronic games, and video game consoles.

9. The method of claim 1, wherein the at least one product comprises a plurality of products and the method further comprises comparing the total recycling credit value of the recycling credits for each of the plurality of products being considered for purchase, wherein:
identifying the at least one product includes identifying the plurality of products being considered for purchase by the consumer;
determining the manufacturer of the at least one product includes determining a manufacturer of each product of the plurality of products;
for each product of the plurality of products, comparing multiplying, and summing respectively includes:
comparing, by the processing device, the manufacturer of the product of the plurality of products with the corresponding manufacturer of the material recycled for each recycling credit,
for each recycling credit associated with the manufacturer of the product of the plurality of products, multiplying, by the processing device, the associated initial credit value of the recycling credit by the factor to obtain the additional credit value for the recycling credit, and
summing, by the processing device, the additional credit values and the initial credit values by to determine the total recycling credit value usable as credit for purchase of the corresponding product;
wherein the method further comprises:
determining, by the processing device, a product of the plurality of products that has a largest total recycling credit value; and
providing to the consumer at least a name of the product of the plurality of products that has the largest total recycling credit value.

10. The method of claim 9, further comprising establishing, by the manufacturer of each product, a value of the factor, wherein the value of the factor is greater than zero.

11. (canceled)

12. The method of claim 9, further comprising:
providing the initial credit values of the recycling credits with funding from a recycling center;
providing a value of the additional credit values with funding from at least one manufacturer of at least one product of the plurality of products; and
storing information regarding one or more of: the consumer, recycling credits of the consumer, manufacturers associated with the recycling credits, and a value of the factor in the database for access by one or more of: the consumer, manufacturers, recycling centers and retail outlets.

13. The method of claim 9, wherein:
the method establishes a value of recycling credits usable for purchase of new products; and
communicating with the data storage and processing system comprises receiving recycling credits associated with recycling of electronic products.

14. (canceled)

15. (canceled)

16. A method to establish a value of recycling credits usable for a product being considered for purchase, the method comprising:
identifying the product being considered for purchase by a consumer;
determining a manufacturer of the product being considered for purchase;
receiving, by a processing device, recycling credits associated with the consumer, wherein each recycling credit has an initial credit value and is associated with a manufacturer of a recycled material;
assigning, by the processing device, to each manufacturer of the recycled material a corresponding factor to enhance the initial credit values of recycling credits associated with that manufacturer, wherein a value of each factor in relation to the product being considered for purchase is established by the manufacturer of the product being considered for purchase;
for each recycling credit, multiplying, by the processing device, the initial credit value of the recycling credit by the corresponding factor to obtain additional credit values for the recycling credits; and
summing, by the processing device, the additional credit values and the initial credit values to determine a total recycling credit value usable as credit for purchase of the product being considered for purchase.

17. The method of claim 16, further comprising:
providing the initial credit values of the recycling credits with funding from a recycling center; and
providing a value of the additional credit values with funding from the manufacturer of the product being considered for purchase.

18. The method of claim 17, wherein assigning to each manufacturer the corresponding factor comprises assigning to each manufacturer a corresponding factor having a value greater than or equal to zero.

19. (canceled)

20. The method of claim 17, further comprising storing information regarding one or more of: the consumer, recycling credits of the consumer, the manufacturers associated with the recycling credits, and the factors assigned to the manufacturers in a database accessible by one or more of: consumers, recycling centers, manufacturers, and retail outlets.

21. The method of claim 17, wherein:
the method establishes a value of recycling credits usable for purchase of a new product; and
the material recycled is at least one electronic device selected from a group that includes cell phones, televisions, tablet computers, e-readers, laptop computers, monitors, desktop computers, portable media players, handheld electronic games, and video game consoles.

22. (canceled)

23. A system to provide valuation of recycling credit on a basis of at least one product being considered for purchase by a consumer, the system comprising:
a processing device; and
a non-transitory computer-readable storage medium in operable communication with the processing device, wherein the computer-readable storage medium contains one or more programming instructions that, in response to execution, cause the processing device to:
identify a product being considered for purchase by the consumer,
determine a manufacturer of the product,
identify recycling credits associated with the consumer, wherein each recycling credit has an initial credit value and is associated with a corresponding manufacturer of a recycled material,
compare the manufacturer of the product with the corresponding manufacturer associated with each recycling credit,
for each recycling credit associated with the manufacturer of the product, multiply the initial credit value of the recycling credit by a factor to obtain an additional credit value for the recycling credit, and
sum the additional credit values and the initial credit values to determine a total recycling credit value usable as credit for purchase of the product being considered for purchase.

24. The system of claim 23, wherein the factor has a value established by the manufacturer of the product, and the value of the factor is greater than zero.

25. (canceled)

26. The system of claim 23, wherein:
the product being considered is a new product; and
the initial credit value of the recycling credit is established by a recycling center, and a value of the additional credit values is provided by the manufacturer of the product.

27. The system of claim 23, wherein the system is configured to provide valuation of recycling credit and to compare a value of the recycling credits, and the programming instructions in response to execution cause the processing device to:
identify a plurality of products being considered for purchase by the consumer;
determine a manufacturer of each product of the plurality of products;
for each product of the plurality of products,
compare the manufacturer of the product of the plurality of products with the corresponding manufacturer associated with each recycling credit;
for each recycling credit associated with the manufacturer of the product of the plurality of products, multiply the initial credit value of the recycling credit by a factor to obtain an additional credit value for the recycling credit; and
sum the additional credit values and the initial credit values to determine a total recycling credit value usable as credit for purchase of the product of the plurality of products; and
determine which product of the plurality of products has a largest recycling credit value.

28. The system of claim 27, wherein:
the factor has a value established by the manufacturer of the product of the plurality of products, wherein the value of the factor is greater than zero;
the products being considered for purchase are new products;
the initial credit value of the recycling credits is established by a recycling center, and a value of the additional credit values is provided by the manufacturer of the product of the plurality of products; and
the non-transitory computer-readable storage medium is configured to store information regarding at least one of: the consumer, recycling credits of the consumer, manufacturers associated with the recycling credits, and a value of the factor, wherein the non-transitory computer-readable storage medium is accessible by the processing device to determine the total recycling credit value.

29-35. (canceled)
